(19) United States
(12) Patent Application Publication
(10) Pub. No.: US 2019/0250454 A1
(43) Pub. Date: Aug. 15, 2019

(54) FLAT PANEL DISPLAY COOLING APPARATUS

(71) Applicant: Visteon Global Technologies, Inc., Van Buren Township, MI (US)

(72) Inventors: Benoit Chauveau, Mery Sur Oise (FR); Jean-Christophe Joly-Vuillemin, Cergy (FR)

(21) Appl. No.: 15/897,843

(22) Filed: Feb. 15, 2018

(51) Int. Cl. G02F 1/1333; G02F 1/1335

(52) U.S. Cl. CPC G02F 1/133385; G02F 1/1339; G02F 1/133528

(57) ABSTRACT

A flat panel display cooling apparatus includes a display panel having a first sheet of light transmissive material and an intermediate layer, together defining a first compartment holding a liquid crystal to generate an image. A cooling cell, having a second sheet of light transmissive material, extends in a flat plane parallel and spaced apart from the intermediate layer, defining a second compartment holding a cooling fluid to regulate the temperature of the liquid crystal. A second seal is disposed between the second sheet and the intermediate layer and enclosing the second compartment. Ports may extend into the second compartment, such as through the second seal, to allow the cooling fluid to be circulated out of the second compartment to carry heat away from the liquid crystal. Direct transfer of heat from the cooling cell is also provided, such as where the cooling cell extends beyond the display panel.

### BACKGROUND

Flat panel display devices including display panels such as Liquid Crystal Displays (LCDs) or Thin-Film Transistor (TFT) displays are used for a variety of different applications and for use in different environments. One particularly harsh environment is in vehicular applications where interior temperatures can range from −40 to 170 degrees Fahrenheit. Such flat-panel displays are commonly provided with back-lighting or edge lighting, which can further heat the display panels. Liquid Crystal Displays are available for use in a wide range of temperatures; however, their operation may still be impaired when subjected to extreme temperatures. Furthermore, high temperatures may reduce the useful life of display panels. There exists a need for a cooling apparatus to remove excess heat from a flat panel display.

### SUMMARY

The invention provides for a flat panel display cooling apparatus including a display panel having a first sheet of light transmissive material such as glass extending in a flat plane. The display panel also includes an intermediate layer disposed parallel and spaced apart from the first sheet to define a first compartment therebetween holding a liquid crystal to generate an image. A first seal extends between the first sheet and the intermediate layer and encloses the first compartment.

The flat panel display cooling apparatus also includes a cooling cell having a second sheet of light transmissive material such as glass extending in a flat plane parallel and spaced apart from the intermediate layer and defining a second compartment therebetween. The second compartment holds a cooling fluid to regulate the temperature of the liquid crystal. A second seal is disposed between the second sheet and the intermediate layer and enclosing the second compartment.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cut-away side view of a flat panel display cooling apparatus;

FIG. 2 is a cut-away side view of another embodiment of a flat panel display cooling apparatus;

FIG. 3 is a cut-away side view of another embodiment of a flat panel display cooling apparatus;

FIG. 4 is a cut-away side view of another embodiment of a flat panel display cooling apparatus;

FIG. 5A is a cut-away side view of a cooling cell for use with a flat-panel display;

FIG. 5B is a cut-away front view of the cooling cell of FIG. 5A;

FIG. 5C is a top view of the cooling cell of FIG. 5A;

FIG. 6 is a cut-away side view of the cooling cell of FIG. 5A with a flat panel display;

FIG. 7 is a schematic flow diagram of a display cooling apparatus;

FIG. 8 is a flow chart of a first method for operating a flat panel display cooling apparatus; and

FIG. 9 is a flow chart of a second method for operating a flat panel display cooling apparatus.

### DETAILED DESCRIPTION

Referring to the Figures, wherein like numerals indicate corresponding parts throughout the several views, a flat panel display cooling apparatus 20 is provided.

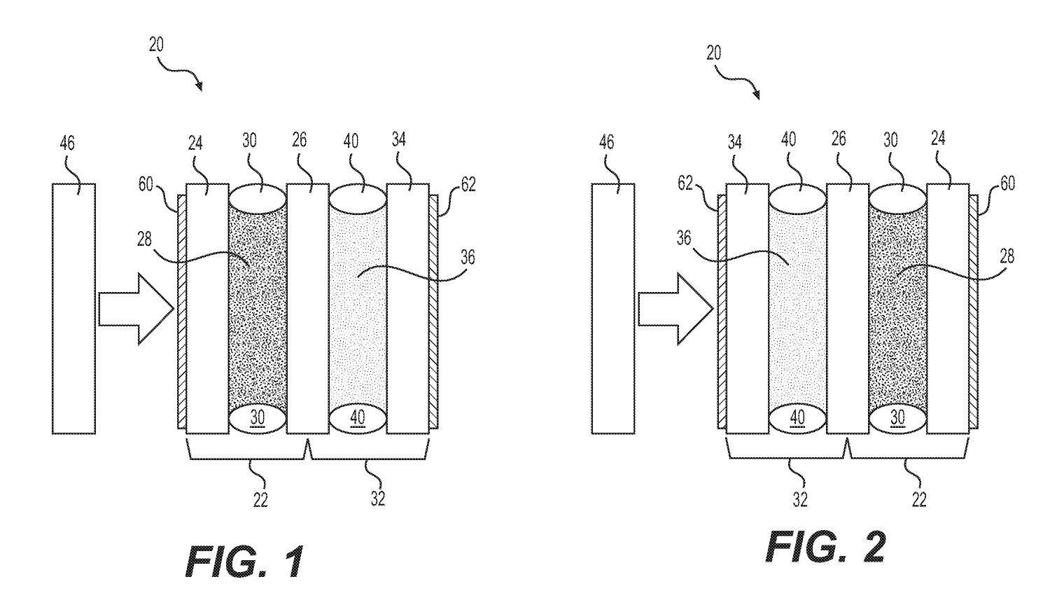

As shown in FIG. 1, the flat panel display cooling apparatus 20 includes a display panel 22 having a first sheet 24 of light transmissive material such as glass extending in a flat plane. The display panel 22 also includes an intermediate layer 26 disposed parallel and spaced apart from the first sheet 24 to define a first compartment 28 therebetween holding a liquid crystal to generate an image. A first seal 30 extends between the first sheet 24 and the intermediate layer 26 and encloses the first compartment 28. The first seal 30 may be, for example, a gasket 56 of resilient material such as rubber and may extend in a closed path about a peripheral edge of the first sheet 24 and/or the intermediate layer 26.

The flat panel display cooling apparatus 20 also includes a cooling cell 32 having a second sheet 34 of light transmissive material such as glass extending in a flat plane parallel and spaced apart from the intermediate layer 26 and defining a second compartment 36 therebetween. The second compartment 36 holds a cooling fluid to regulate the temperature of the liquid crystal. A second seal 40 is disposed between the second sheet 34 and the intermediate layer 26 and enclosing the second compartment 36. The second seal 40 may be, for example, a gasket 56 of resilient material such as rubber and may extend in a closed path about a peripheral edge of the second sheet 34 and/or the intermediate layer 26. Preferably, the first sheet 24 and the second sheet 34 are each made of glass. However, either or both of them may be made of other materials such as plastic.

The cooling fluid within the second compartment 36 of the cooling cell 32 is preferably a liquid such as water, alcohol, glycol, or a mixture thereof. However, the cooling fluid may be a gas or a refrigerant that changes phases to remove heat. The cooling fluid may include additives for lowering the freezing temperature or raising the boiling point or for other purposes such as inhibiting corrosion, or preventing bacteria and/or algae from growing therein.

In one exemplary embodiment, and as shown in FIG. 6, the intermediate layer 26 may include a third sheet 42 of light transmissive material and a fourth sheet 44 of light transmissive material. Preferably, one or both of the third sheet 42 and/or the fourth sheet 44 are made of glass, however, other materials such as acrylics like Lexan may be used.

As shown in FIGS. 1 and 2, the flat panel display cooling apparatus 20 may further include a backing panel 46 parallel and adjacent one of the display panel 22 or the cooling cell 32 to provide a distributed illumination across the display panel 22. The backing panel 46 may include a backlight to supply the light through the display panel 22. The backing panel 46 may include a light guide to direct the light through the light through the display panel 22, such as the type used for an edge-lit display. The backing panel 46 may also include other components such as, for example, a reflector, and/or a diffuser for evenly distributing the illumination.

The backing panel 46 may be separated from other parts of the flat panel display cooling apparatus 20 as shown in FIGS. 1 and 2. Alternatively, the backing panel 46 may be in direct contact with another part of the flat panel display cooling apparatus 20. In the embodiment shown in FIG. 1, the display panel 22 is disposed between the backing panel 46 and the cooling cell 32. In the alternative embodiment shown in FIG. 2, the cooling cell 32 is disposed between the backing panel 46 and the display panel 22.

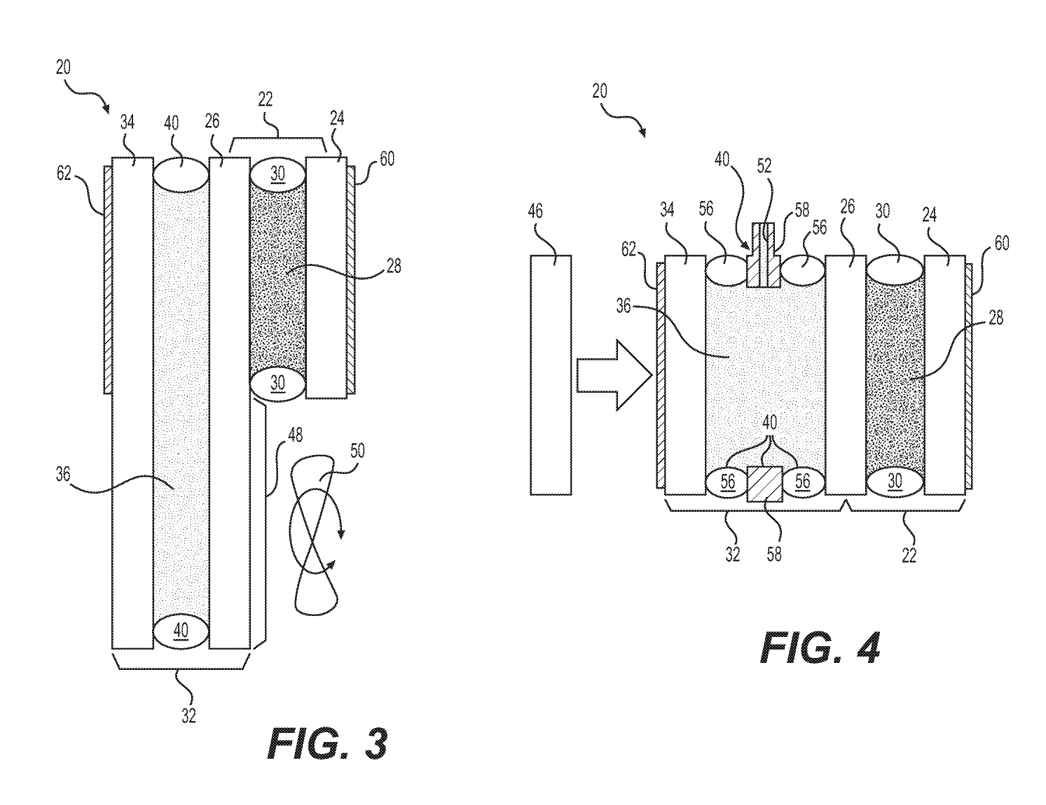

In the embodiment shown in FIG. 3, the cooling cell 32 extends beyond the display panel 22 in a direction parallel to the flat plane to define an extended region 48 with the second compartment 36 not overlapping the first compartment 28. This extended region 48 is used for removing heat from the cooling cell 32, even while the other area of the cooling cell 32 which contacts display panel 22 is removing heat therefrom. In other words, the cooling cell dissipates heat from the display panel 22 and dissipates that heat over the extended region 48. As also shown in FIG. 3, a fan 50 may be used to blow air upon the extended region 48 of the cooling cell 32 and to increase the ability of the cooling cell 32 to remove heat from the display panel 22.

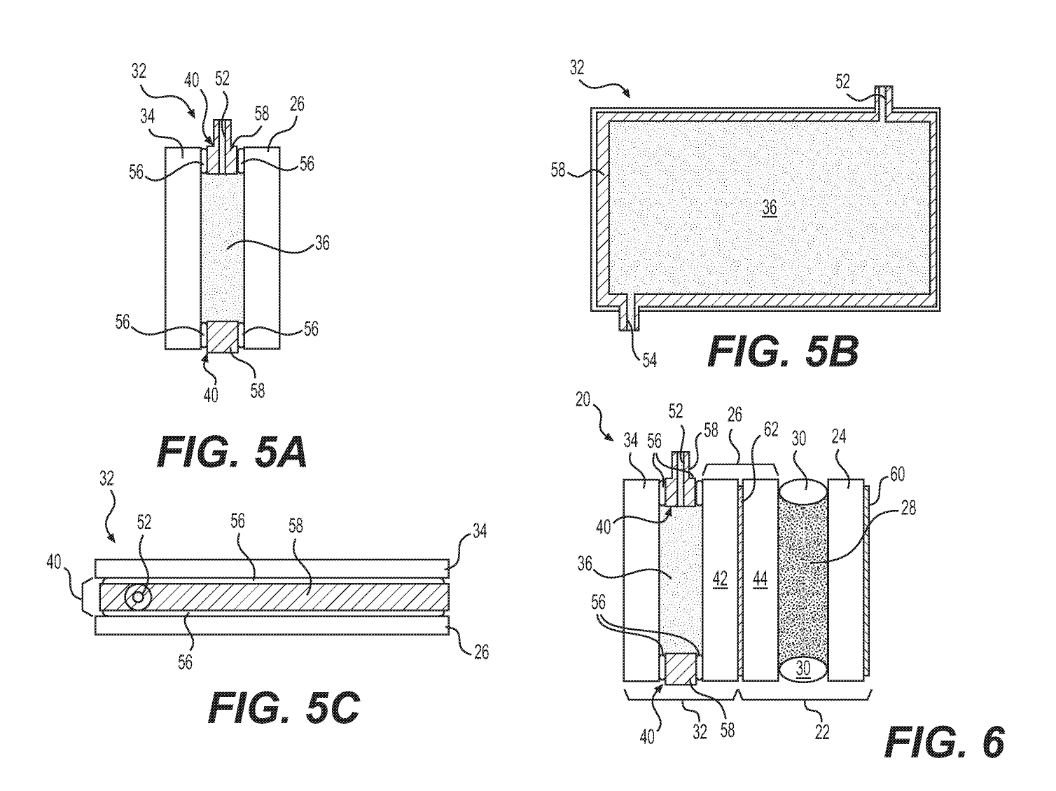

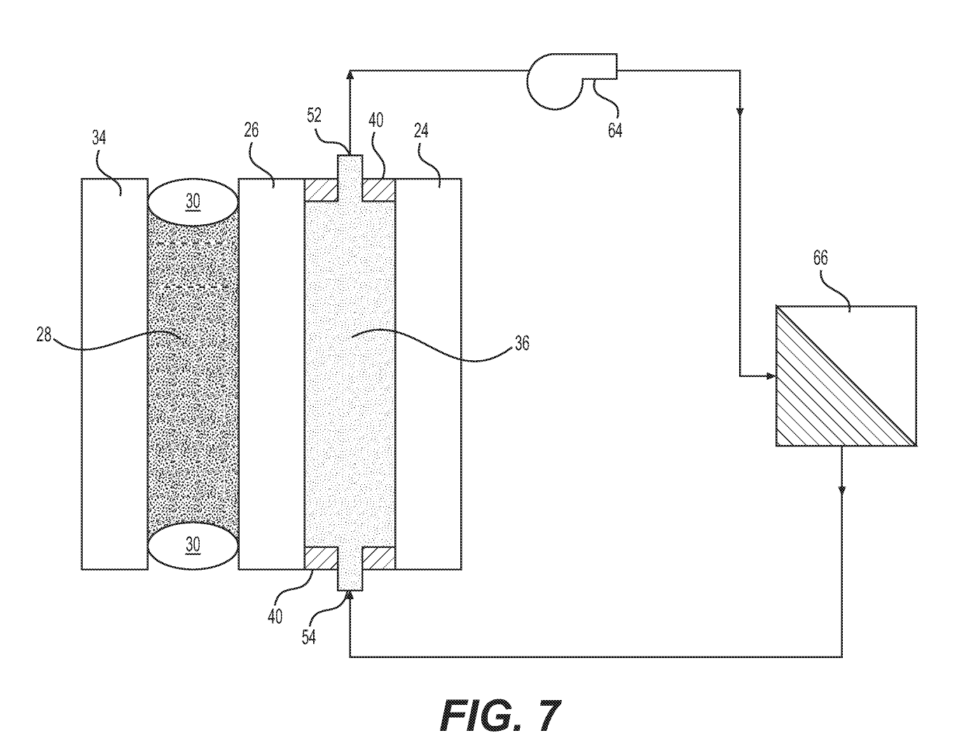

As shown in the embodiment of FIGS. 5A-5C, the flat panel display cooling apparatus 20 may include a first port 52 defining a path of fluid communication into the second compartment 36 and a second port 54 defining a path of fluid communication into the second compartment 36 for circulation of the cooling fluid therethrough. One or both of the ports 52, 54 may extend through the second seal 40 as shown in FIGS. 5A-5C. However, either or both of the ports 52, 54 may alternately extend through the second sheet 34 and/or the intermediate layer 26. As best shown in FIG. 7, the cooling fluid may be circulated active means such as with a pump 64 or a blower 64. The cooling fluid may also be circulated by passive means, relying on a temperature differential to cause the cooling fluid to circulate. The cooling fluid then transfers heat away from the display panel 22. A heat exchanger 66 may be used to remove heat from the cooling fluid by transferring the heat to a secondary fluid. The heat exchanger 66 may be, for example, a liquid-to-liquid device; a liquid-to-refrigerant device, such as in a chiller machine; or a liquid-to-gas device, such as a radiator.

As shown in FIGS. 4 and 5A-5C, the second seal 40 may include a frame 58 of rigid material surrounding the second compartment 36 secured between the second sheet 34 and the with a gasket 56 of resilient material such as rubber or silicone. Preferably, the frame 58 defines one or both of the both of the ports 52, 54, thereby providing rigidity allowing for a uniform flow of coolant. Furthermore, and as best shown in FIGS. 5A-5C, the frame 58 may further define one or more fittings adjacent to the ports 52, 54 for connecting tubes or pipes to allow for coolant flow into and out of the second compartment 36.

As shown in FIGS. 1-4 and 6, the flat panel display cooling apparatus 20 also includes two or more polarizers 60, 62 that each function to filter light passing therethrough and to only pass light polarized in a given direction. The polarizers 60, 62 may thereby allow the liquid crystal to selectively cause different portions of the image to be visible as the parts of the liquid crystal alter the polarization of light passing therethrough. A first polarizer 60 extends in a plane parallel and adjacent to said display panel 22 and a second polarizer 62 extends parallel to and spaced apart from said first polarizer 60 and sandwiching said display panel 22 between said polarizers 60, 62. As shown in FIG. 6, one of the polarizers 60, 62 may be disposed within the intermediate layer 26 between the cooling cell 32 and the display panel 22. Alternatively, and as shown in FIGS. 1-4, the polarizers 60, 62 may each be disposed adjacent a corresponding one of the display panel 22 and the cooling cell 32 with the display panel 22 and the cooling cell 32 being between the polarizers 60, 62.

Methods 100, 200 for operating different embodiments of the flat panel display cooling apparatus 20 are also provided.

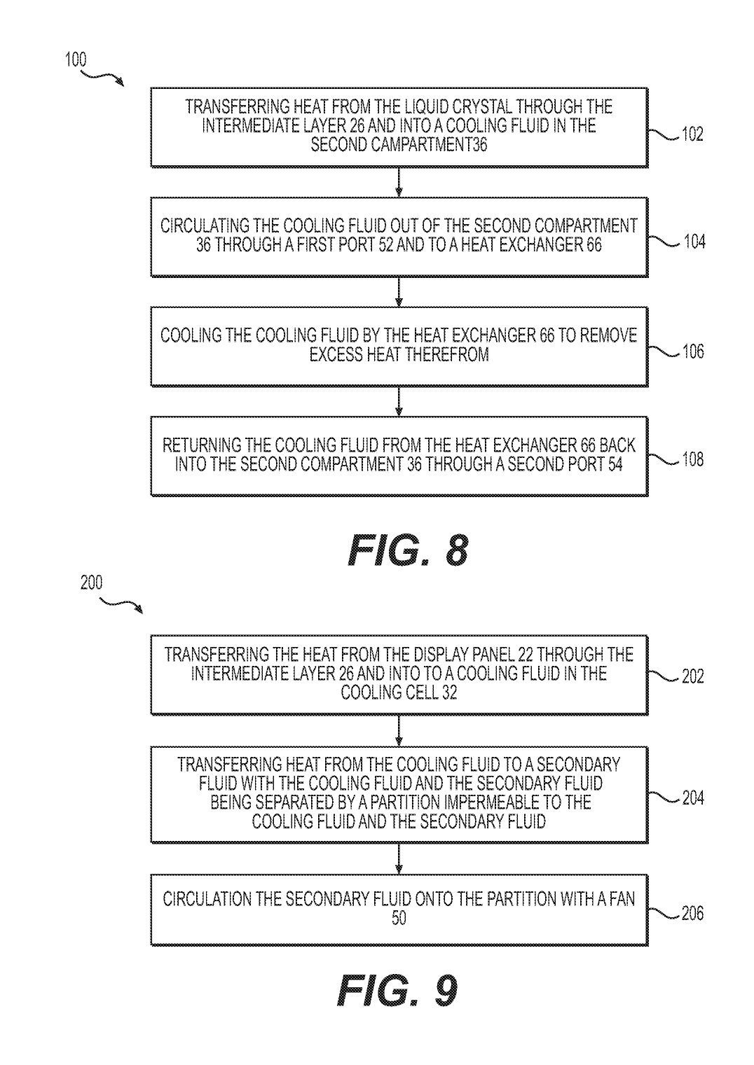

A first method 100 for operating a flat panel display cooling apparatus 20 including a cooling cell 32 having a second compartment 36 separated by an intermediate layer 26 from a first compartment 28 holding a liquid crystal is shown in the flow chart of FIG. 8. The flat panel display cooling apparatus 20 used in the first method 100 is best shown in the embodiment of FIG. 7.

The first method 100 includes 102 transferring heat from the liquid crystal through the intermediate layer 26 and into a cooling fluid in the second compartment 36. Because the intermediate layer 26 separates the first compartment 28 from the second compartment 36, most of the heat transfer is likely to be in the form of conduction and/or convection. Heat may also be transferred into the cooling fluid by radiant energy.

The first method 100 also includes 104 circulating the cooling fluid out of the second compartment 36 through a first port 52 and to a heat exchanger 66. This circulating may be through a closed loop, such as with water or coolant through a tube or a series of pipes. A blower 64 or pump 64 may be used to actively cause the cooling fluid to circulate. The circulation may also be passive, caused differentials in the temperature of the cooling fluid in different areas.

The first method 100 also includes 106 cooling the cooling fluid by the heat exchanger 66 to remove excess heat therefrom.

The first method 100 also includes 108 returning the cooling fluid from the heat exchanger 66 back into the second compartment 36 through a second port 54.

A second method 200 is provided for operating a flat panel display cooling apparatus 20 including a cooling cell 32 having a second sheet 34 and an intermediate layer 26 separating the cooling cell 32 from a display panel 22, is shown in the flow chart of FIG. 9. The flat panel display cooling apparatus 20 used in the second method 200 is best shown in the embodiment of FIG. 3.

The second method 200 includes 202 transferring heat from the display panel 22 through the intermediate layer 26 and into to a cooling fluid in the cooling cell 32.

The second method 200 proceeds with 204 transferring heat from the cooling fluid to a secondary fluid with the cooling fluid and the secondary fluid being separated by a partition impermeable to the cooling fluid and the secondary fluid. In the embodiment of FIG. 7, the partition is in the heat exchanger 66, and the secondary fluid is either a liquid or a gas such as ambient air in the case of a heat exchanger 66 that is a radiator.

According to an aspect, the partition may include the second sheet 34 or the intermediate layer 26. In the embodiment of FIG. 3, the intermediate layer 26 functions as the partition and allows heat to be transferred from the cooling fluid in the cooling cell 32 to the air, which is blown thereupon by the fan 50. If the fan 50 were located on the other side of the extended region 48 (the left side in FIG. 3), then the second sheet 34 would function as the partition, thereby allowing heat to be transferred from the cooling fluid in the cooling cell 32 to the air.

According to a further aspect, and as best shown in the embodiment of FIG. 3, the secondary fluid may be a gas such as air, and the second method 200 may include the step of 206 circulating the secondary fluid onto the partition with a fan 50.

Obviously, many modifications and variations of the present invention are possible in light of the above teachings and may be practiced otherwise than as specifically described while within the scope of the appended claims.

What is claimed is:

1. A flat panel display cooling apparatus comprising:
a display panel including a first sheet of light transmissive material extending in a flat plane, and an intermediate layer disposed parallel and spaced apart from said first sheet and defining a first compartment therebetween holding a liquid crystal to generate an image, and a first seal extending between said first sheet and said intermediate layer and enclosing said first compartment;
a cooling cell including a second sheet of light transmissive material extending in a flat plane parallel and spaced apart from said intermediate layer and defining a second compartment therebetween holding a cooling fluid to regulate the temperature of said liquid crystal, and a second seal disposed between said second sheet and said intermediate layer and enclosing said second compartment.

2. The flat panel display cooling apparatus as set forth in claim 1 wherein said intermediate layer includes a third sheet of light transmissive material and a fourth sheet of light transmissive material.

3. The flat panel display cooling apparatus as set forth in claim 1 further including a backing panel parallel and adjacent one of said display panel or said cooling cell to provide a distributed illumination across said display panel; and
wherein said cooling cell is disposed between said backing panel and said display panel.

4. The flat panel display cooling apparatus as set forth in claim 1 further including a backing panel to provide a distributed illumination across said display panel; and
wherein said display panel is disposed between said backing panel and said cooling cell.

5. The flat panel display cooling apparatus as set forth in claim 1 further including a backing panel to provide a distributed illumination across said display panel; and
wherein said backing panel is a backlight to supply said light through said display panel.

6. The flat panel display cooling apparatus as set forth in claim 1 further including a backing panel to provide a distributed illumination across said display panel; and
wherein said backing panel includes a light guide to direct said light through said light through said display panel.

7. The flat panel display cooling apparatus as set forth in claim 1 wherein said cooling cell extends beyond said display panel in a direction parallel to said flat plane to define an extended region with said second compartment not overlapping said first compartment.

8. The flat panel display cooling apparatus as set forth in claim 7 further including a fan to blow upon said extended region of said cooling cell.

9. The flat panel display cooling apparatus as set forth in claim 1 further including a first port defining a path of fluid communication into said second compartment and a second port defining a path of fluid communication into said second compartment for circulation of said cooling fluid therethrough.

10. The flat panel display cooling apparatus as set forth in claim 9 wherein at least one of said ports extends through said second seal.

11. The flat panel display cooling apparatus as set forth in claim 1 wherein said second seal includes a frame of rigid material surrounding said second compartment and secured between said second sheet and said intermediate layer with a gasket of resilient material.

12. The flat panel display cooling apparatus as set forth in claim 11 wherein said frame defines a first port defining a path of fluid communication into said second compartment; and
wherein said frame defines a second port defining a path of fluid communication into said second compartment for circulation of said cooling fluid therethrough.

13. The flat panel display cooling apparatus as set forth in claim 1 wherein said cooling fluid is a liquid.

14. The flat panel display cooling apparatus as set forth in claim 1 further including a first polarizer extending in a plane parallel and adjacent to said display panel; and
a second polarizer extending parallel to and spaced apart from said first polarizer and sandwiching said display panel between said polarizers.

15. The flat panel display cooling apparatus as set forth in claim 14 wherein at least one of said polarizers is disposed within said intermediate layer between said cooling cell and said display panel.

16. The flat panel display cooling apparatus as set forth in claim 14 wherein said polarizers are each disposed adjacent a corresponding one of said display panel and said cooling cell and with said display panel and said cooling cell being disposed between said polarizers.

17. A method for operating a flat panel display cooling apparatus including a cooling cell having a second compartment separated by an intermediate layer from a first compartment holding a liquid crystal, and comprising:
transferring heat from the liquid crystal through the intermediate layer and into a cooling fluid in the second compartment;
circulating the cooling fluid out of the second compartment through a first port and to a heat exchanger;
cooling the cooling fluid by the heat exchanger to remove excess heat therefrom; and
returning the cooling fluid from the heat exchanger back into the second compartment through a second port.

18. A method for operating a flat panel display cooling apparatus including a cooling cell having a second sheet and an intermediate layer separating the cooling cell from a display panel, and comprising:
transferring heat from the display panel through the intermediate layer and into to a cooling fluid in the cooling cell; and
transferring heat from the cooling fluid to a secondary fluid with the cooling fluid and the secondary fluid being separated by a partition impermeable to the cooling fluid and the secondary fluid.

19. The method for operating a flat panel display cooling apparatus as set forth in claim 18 wherein the partition includes the second sheet or the intermediate layer.

20. The method for operating a flat panel display cooling apparatus as set forth in claim 18 wherein the secondary fluid is a gas and further including circulating the secondary fluid onto the partition with a fan.
